(19) United States
(12) Patent Application Publication
(10) Pub. No.: US 2018/0211123 A1
(43) Pub. Date: Jul. 26, 2018

(54) OCCUPANT DETECTION SYSTEM IN A VEHICLE

(71) Applicant: Toyota Research Institute, Inc., Los Altos, CA (US)

(72) Inventors: Hiroshi Yasuda, San Francisco, CA (US); Nikolaos Michalakis, Saratoga, CA (US)

(21) Appl. No.: 15/414,868

(22) Filed: Jan. 25, 2017

(51) Int. Cl. G06K 9/00; H04N 7/18; H04N 5/225; H04N 5/33; B60R 11/04

(52) U.S. Cl. CPC G06K 9/00838; H04N 7/183; B60R 11/04; H04N 5/332; H04N 5/2256

(57) ABSTRACT

An occupant detection system is described. The occupant detection system may comprise a camera, a first interior surface, and an image processing module. The camera may be configured to capture at least a first portion of electromagnetic spectrum. The first interior surface may comprise a first material identified by the first portion of electromagnetic spectrum. The image processing module may be configured to receive an image from the camera, the image comprising the first portion of electromagnetic spectrum; detect the first interior surface based, at least in part, upon the image comprising the first portion of electromagnetic spectrum; and detect a first occupant based, at least in part, on a first absence of the first portion of electromagnetic spectrum in a first area of the image, the first area of the image overlapping the first interior surface in the image.

### TECHNICAL FIELD

The subject matter described herein relates in general to imaging techniques, and more particularly, to an occupant detection system in a vehicle.

### BACKGROUND

Some vehicles include occupant detection systems. Vehicle seats have weight sensors to detect presence of a passenger. Sometimes a camera is used to detect vehicle occupants. Occupant detection with cameras that rely on the visible electromagnetic spectrum is difficult in bright and dim lighting conditions. When an occupant is detected, a seatbelt chime may sound and/or an airbag may be active or not active.

### SUMMARY

This disclosure describes various embodiments for occupant detection in a vehicle. In an embodiment, an occupant detection system is described. The occupant detection system may comprise a camera, a first interior surface, and an image processing module. The camera may be configured to capture at least a first portion of electromagnetic spectrum. The first interior surface may comprise a first material identified by the first portion of electromagnetic spectrum. The image processing module may be configured to receive an image from the camera, the image comprising the first portion of electromagnetic spectrum; detect the first interior surface based, at least in part, upon the image comprising the first portion of electromagnetic spectrum; and detect a first occupant based, at least in part, on a first absence of the first portion of electromagnetic spectrum in a first area of the image, the first area of the image overlapping the first interior surface in the image.

In another embodiment, a method for occupant detection is described. The method may comprise receiving an image comprising at least a first portion of electromagnetic spectrum; detecting a first interior surface based, at least in part, upon the image comprising the first portion of electromagnetic spectrum; and detecting a first occupant based, at least in part, on a first absence of the first portion of electromagnetic spectrum in a first area of the image, the first area of the image overlapping a first interior surface in the image.

In another embodiment, a vehicle is described. The vehicle may comprise a camera, a first interior surface, and an image processing module. The camera may be configured to capture at least a first portion of electromagnetic spectrum. The first interior surface may comprise a first material identified by the first portion of electromagnetic spectrum The image processing module may be configured to receive an image from the camera, the image comprising the first portion of electromagnetic spectrum; detect the first interior surface based, at least in part, upon the image comprising the first portion of electromagnetic spectrum; and detect a first occupant based, at least in part, on a first absence of the first portion of electromagnetic spectrum in a first area of the image, the first area of the image overlapping the first interior surface in the image.

### BRIEF DESCRIPTION OF THE DRAWINGS

FIG. 1 is a diagram of an embodiment of a vehicle interior comprising an occupant detection system.

FIG. 2 is a diagram of an embodiment of a vehicle interior as captured by a hyperspectral camera.

FIG. 3 is a flow diagram of an embodiment of a method for occupant detection in a vehicle.

FIG. 4 is a flow diagram of an embodiment of a method for calibrating an occupant detection system.

FIG. 5 is a block diagram of an embodiment of an occupant detection system.

FIG. 6 is a block diagram of an embodiment of an occupant detection system.

### DETAILED DESCRIPTION

Described herein are embodiments of a system and method for occupant detection. In an embodiment, a vehicle interior may be constructed using materials that reflect or absorb specific electromagnetic spectrum. As used herein constructed may include adding the materials to the interior components of the vehicle while they are built, or any time after the vehicle had been constructed. For example, during manufacture of the interior components the seats may be constructed using a fabric that has the material weaved into it, or a coating of the material may be applied to the interior surfaces after the vehicle has been manufactured. In any case, the interior components comprise the material. In some embodiments, the material may be selected based upon electromagnetic spectrum that is reflected. In some embodiments, the material may be selected based upon electromagnetic spectrum that is absorbed. For example, materials that are readily detected by an image capture device. In another example, materials that reflect or absorb electromagnetic spectrum similar to clothing or human skin may not be selected to avoid possible confusion of the occupant detection system. A camera or other imaging device may be selected to capture images of the interior of the vehicle. The images may be captured using a camera designed to capture the electromagnetic spectrum reflected or absorbed by the interior components. In an embodiment, the camera may be a hyperspectral camera or some other camera for capturing electromagnetic spectrum that may not be visible to the human eye.

An image processing module may receive the captured images and analyze them to determine the presence of occupants in the vehicle. For example, the image processing module may determine the location of the driver's seat based upon reflected or absorbed electromagnetic spectrum. Different surfaces of the vehicle may be constructed of materials that reflect or absorb different portions of electromagnetic spectrum. Based upon the detected reflected or absorbed electromagnetic spectrum, the vehicle may determine which part of the vehicle it is observing. If there is a portion of the driver's seat that is not reflecting or absorbing the electromagnetic spectrum, the image processing module may determine that an occupant is in the driver's seat, blocking the reflection or absorption. In an embodiment, the camera may be configured to determine the orientation of a vehicle occupant based upon an outline of the area that is not reflecting or absorbing the electromagnetic spectrum. For example, the image processing module may be programmed with expected profiles of occupants at different orientations. The image processing module may compare the captured image to the stored profiles and make a determination of occupant orientation, e.g., which way the occupant is facing, based upon the comparison. A similar technique may be used to determine the presence of cargo in the vehicle. For example, the image processing module may detect an area where an interior surface is not reflecting or absorbing the electromagnetic spectrum. If the detected area is smaller than a person, uniquely shaped, or possessing some other identifying characteristic, the image processing module may determine that cargo is present in the vehicle.

The image processing module may be configured to detect interaction with various interior components. In an embodiment, certain components within the vehicle may be constructed using materials that reflect or absorb differing electromagnetic spectrum. For example, a door handle may be constructed using a material that reflects a first portion of electromagnetic spectrum and a steering wheel may be constructed using a material that reflects a second different portion of electromagnetic spectrum. In another example, patterns, e.g. stripes, polka dots, zigzags, etc., may be created on the interior components of the vehicle by arranging materials that reflect or absorb differing electromagnetic spectrum into a pattern. The image processing module may be programmed with information about the various interior surfaces and what portions of electromagnetic spectrum they reflect or absorb. Using this information and images captured by the camera, the image processing module may determine that an occupant is reaching for an interior component. The image processing module may alert vehicle subsystem of the anticipated interaction. For example, the image processing module may determine the driver is reaching for the steering wheel and notify an autonomous driving system of the anticipated interaction with the steering wheel.

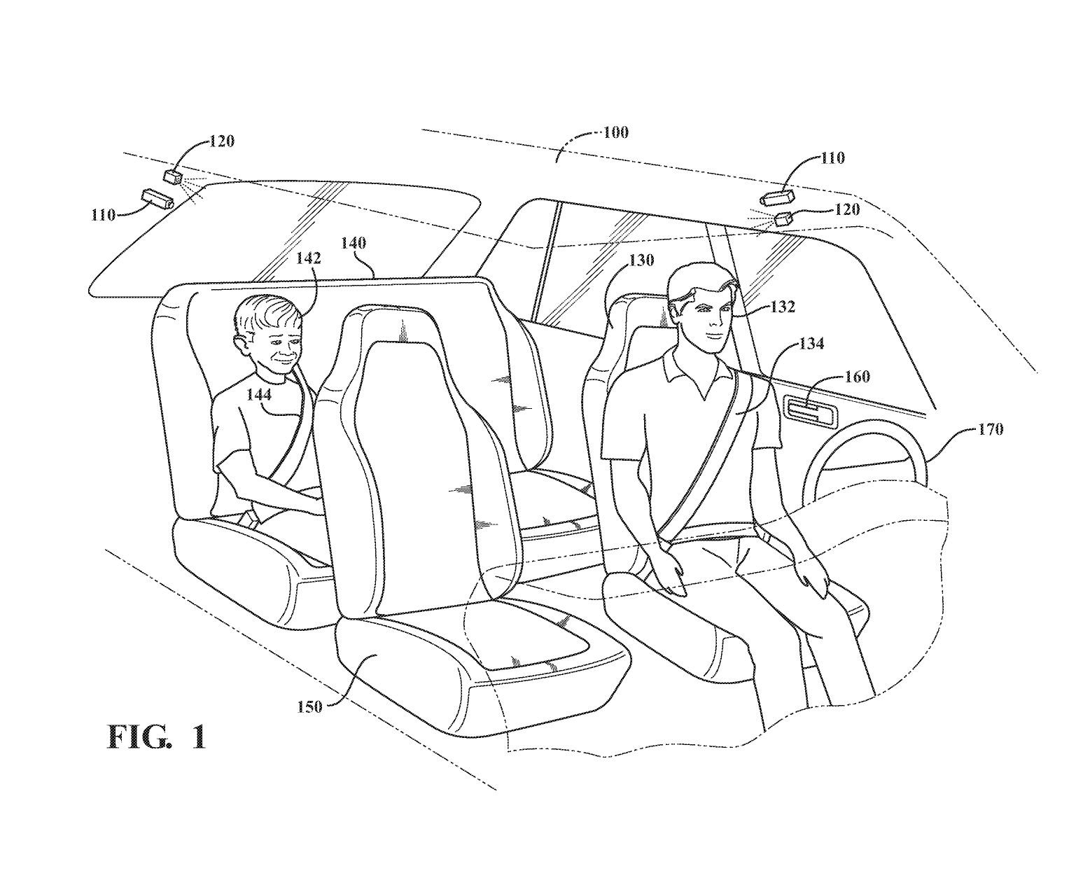

FIG. 1 is a diagram of an embodiment of a vehicle interior 100 comprising an occupant detection system. The vehicle interior 100 may contain one or more cameras 110. Cameras 110 may be hyperspectral cameras, stereo cameras, or some other type of camera configured to capture electromagnetic spectrum. In an embodiment, cameras 110 may be configured to detect electromagnetic spectrum not visible to the human eye and/or electromagnetic spectrum that is visible to human eyes. Two cameras 110 are present in the embodiment depicted, however one or more cameras 110 may be used. The number of cameras 110 may be selected as necessary to capture the surfaces of the vehicle interior 100. In some embodiments, the vehicle interior 100 may comprise an auxiliary light source 120. Two auxiliary light sources 120 are present in the embodiment depicted, however no auxiliary light sources 120 or one or more auxiliary light sources 120 may be present. Whether an auxiliary light source 120 is present may be determined based upon the materials used in the vehicle interior 100. Auxiliary light sources 120 may be configured to provide additional electromagnetic spectrum, e.g. lasers emitting a particular portion of electromagnetic spectrum or ultraviolet light, to the vehicle interior 100 in situations where camera 110 may have difficulties capturing images of the vehicle interior 100.

For example, auxiliary light source 120 may be an ultraviolet light. A pulse of ultraviolet light may be used to illuminate services of the vehicle constructed with materials that reflect or absorb UV light. In this example, cameras 110 may be calibrated to capture the reflected or absorbed ultraviolet light. In another example, auxiliary light sources 120 may not be present. In this example, cameras 110 may be configured for hyperspectral imaging. The surfaces of the vehicle interior 100 may be constructed with materials that reflect or absorb different portions of the electromagnetic spectrum. Other combinations of types of cameras 110 and/or auxiliary light sources 120 may be used. In some embodiments, the images captured by cameras 110 may capture electromagnetic spectrum that is not visible to the human eye. In some embodiments, the auxiliary light sources 120 may emit electromagnetic spectrum that is not visible to the human eye. Various materials used for constructing the vehicle interior 100 may have unique electromagnetic characteristics that may be captured by cameras 110.

Vehicle interior 100 may comprise one or more seating areas. Vehicle interior 100 may contain driver's seat 130, passenger seat 150, and rear seat 140. Each of the seats may be constructed with a material visible to cameras 110. Vehicle interior 100 may comprise one or more seatbelts. Driver 132 may be secured using seat belt 134. Passenger 142 may be secured using seat belt 144. The vehicle interior 100 may also comprise a door handle 160 and a steering wheel 170. Other components of the vehicle interior 100 may have been omitted from the figure for simplicity. Some or all of the components in vehicle interior 100 may be constructed using materials that reflect or absorb the same or different portions of the electromagnetic spectrum.

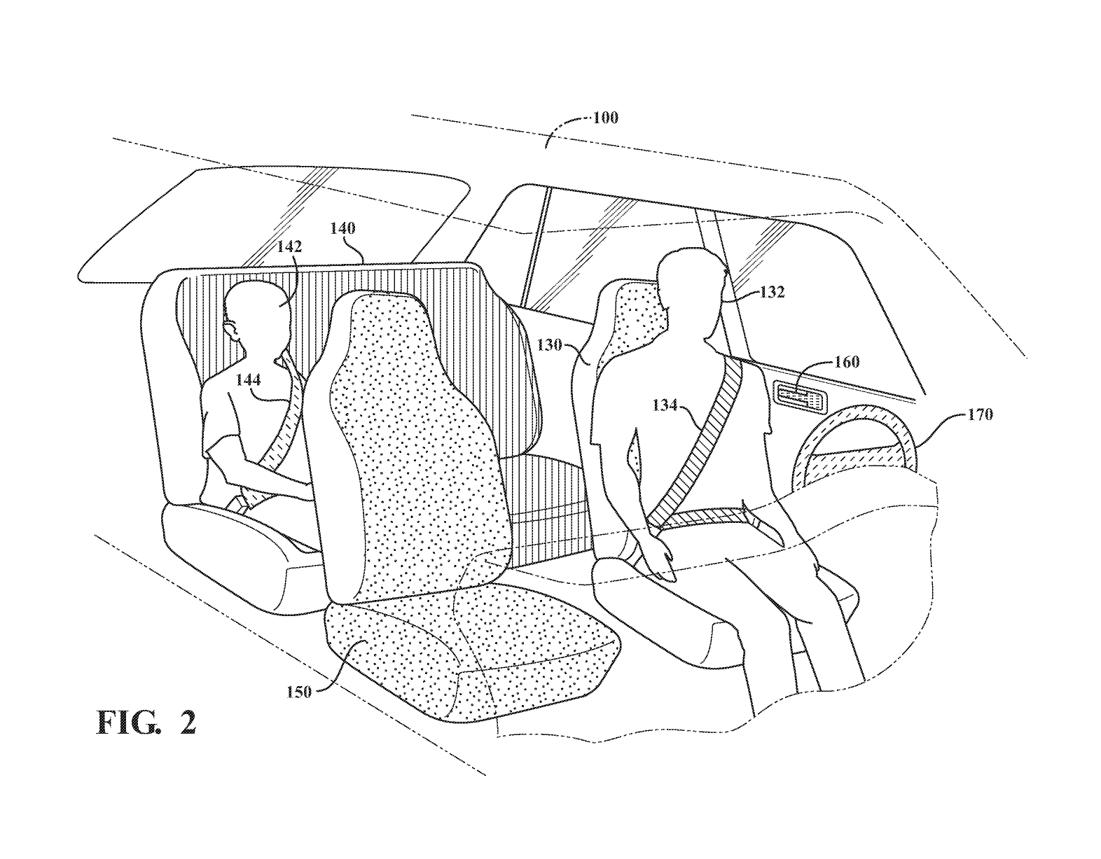

FIG. 2 is a diagram of an embodiment of a vehicle interior 100 as captured by a hyperspectral camera, e.g., camera 110. Different hashes of the components represent different electromagnetic spectrum as captured by a hyperspectral camera. Other types of cameras may be used to capture this type of image based upon the materials used in vehicle interior 100. Driver's seat 130 may be constructed with a material that reflects or absorbs a certain portion of the electromagnetic spectrum. Driver 132 may not reflect the same portion of the electromagnetic spectrum. An electronic control unit (ECU) may be configured with an image processing module for processing images captured by a camera in the vehicle interior. The image processing module may be part of an ECU or may be a standalone module or part of some other system within a vehicle. The image processing module may be able to determine the position of driver 132 based on the reflected or absorbed electromagnetic spectrum of driver's seat 130. For example, the driver 132 may be outlined by the electromagnetic spectrum that is reflected or absorbed by the material used in constructing driver's seat 130. In an embodiment, an image processing module may be configured to determine the orientation of a vehicle occupant based upon an outline of the area that is not reflecting or absorbing the electromagnetic spectrum. For example, the image processing module may be programmed with expected profiles of occupants at different orientations. The image processing module may compare the captured image to the stored profiles and make a determination of occupant orientation, e.g., which way the occupant is facing, based upon the comparison.

Seatbelt 134 may be constructed with a different material that reflects or absorbs a different portion of the electromagnetic spectrum than the material used in construction of driver's seat 130. The image processing module may be able to determine the position of seatbelt 134 based upon reflected or absorbed electromagnetic spectrum. For example, the image processing module may be configured to determine whether or not the seatbelt 134 is in position to secure the driver 132. Constructing the seatbelt 134 with a different material than the material used for driver's seat 130 may allow the image processing module to differentiate between driver's seat 130 and seatbelt 134.

Passenger seat 150 and rear seat 140 may be constructed of materials that reflect or absorb different portions of the electromagnetic spectrum. In other embodiments, some or all of the components of the vehicle interior may be constructed using materials that reflect or absorb the same or similar portions of electromagnetic spectrum. Seatbelt 144 may be constructed using materials that reflect or absorb a different electromagnetic spectrum portion than seatbelt 134 and rear seat 140.

Handle 160 may be constructed of materials that reflects or absorbs different portions of electromagnetic spectrum. Steering wheel 170 may be constructed of materials that reflects or absorbs different portions of electromagnetic spectrum. When driver 132 reaches for handle 160, the camera may capture the driver reaching for the handle 160. The image processing module may be configured to make a determination that the driver is reaching for handle 160 based upon changes in the reflection or absorption of electromagnetic spectrum. Likewise, the image processing module may be configured to make a determination of the drivers reaching for steering wheel 170 based on changes in reflection or absorption of electromagnetic spectrum. The image processing module may notify other vehicle subsystems that the driver is reaching for a particular interior component. For example, the image processing module may notify an autonomous driving system that the driver is reaching for steering wheel 170. The autonomous driving system may take appropriate actions based on the driver reaching for steering wheel 170, e.g., preparing to disable an autonomous driving mode. In another example, the image processing module may notify the door lock system that the driver is reaching for handle 160. In response, the door lock system may unlock the door that is associated with handle 160. Other interior components, for example, a dashboard, interior light switches, audio systems, cup holders, etc., may be monitored for interaction with the driver, and other subsystems may be notified by the image processing module based upon interaction with particular components of the vehicle.

In addition to interior components of the vehicle, other objects may be detected by the image processing module. Devices that may be used primarily in vehicles may be constructed using materials that reflect or absorb a predetermined portion of electromagnetic spectrum. For example, a child car seat manufacturer may include materials that reflect or absorb a predetermined portion of electromagnetic spectrum in the construction of a car seat. The image processing module may determine that a car seat is in the vehicle based upon the reflected or absorbed electromagnetic spectrum. In an embodiment, extra fabric or other material may be included with the vehicle. When an object, e.g., a car seat, is installed in the vehicle, the extra fabric or other material may be placed on the object to indicate to the image processing module the presence of the object in the vehicle. In yet another embodiment, small children may wear a shirt or other item of clothing to indicate to the image processing module its presence in the vehicle.

If one or more the cameras that are monitoring the interior of the vehicle need to be calibrated, the camera may determine the location of the various components of the vehicle interior. Based upon predefined locations of the components identified by the camera, the image processing module may determine the angle of observation of the camera and calibrate the camera accordingly. For example, the camera may detect handle 160 and driver's seat 130. The image processing module may be preprogrammed with the distance between driver's seat 130 and handle 160. Based upon a measured distance between driver's seat 130 and handle 160 and the preprogrammed distance between driver's seat 130 and handle 160, the image processing module may calibrate the camera.

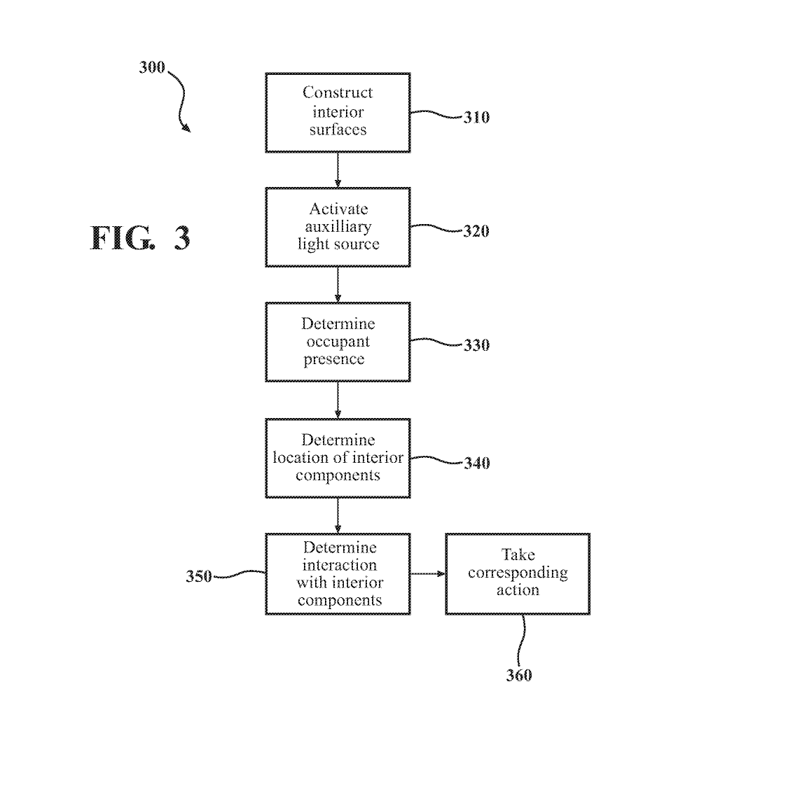

FIG. 3 is a flow diagram of an embodiment of a method 300 for occupant detection in a vehicle. The method 300 may begin at block 310 when the interior components of the vehicle are constructed using specific materials that reflect or absorb one or more portions of electromagnetic spectrum. Constructing the interior surfaces may include coating them with a particular material or building them from a particular material. The electromagnetic spectrum that is absorbed or reflected by the various interior components may be programmed for recognition into an image processing module.

An auxiliary light source may be activated at block 320. Block 320 is an optional step that may not be performed if there are no auxiliary light sources in the vehicle. The auxiliary light source may be selected to provide electromagnetic spectrum that is either absorbed or reflected by components of the vehicle interior.

At block 330, an image processing module may receive images captured by a camera in the vehicle. One or more cameras may be used in the vehicle for capturing images. The image processing module may receive the images and determine whether occupants are in the vehicle. The imaging processing module may be programmed to search for areas where an expected electromagnetic spectrum is not reflected or absorbed. In areas where the expected electromagnetic spectrum is not reflected or absorbed, the image processing module may determine that an occupant or cargo is present. The image processing module may be programmed to determine the size and/or shape of the area that is not reflecting or absorbing the expected electromagnetic spectrum. Based, at least in part, upon the determined size and/or shape, the image processing module may determine whether it is an occupant or cargo that is present in the vehicle. The image processing module may notify vehicle subsystems of the presence and/or location of occupants in the vehicle.

At block 340, the image processing module may determine the location of various interior components. The image processing module may make determinations of location based upon reflected or absorbed electromagnetic spectrum. In some embodiments, the components of the interior of the vehicle may all reflect the same or similar electromagnetic spectrum. In this case, the image processing module may not be able to determine the location of individual interior components.

If the image processing module is able to determine the location of interior components the method may continue at block 350 where an image processing module may determine an occupant's interaction with interior components. The image processing module may analyze an image captured by the camera in the vehicle interior. The analysis may determine that an occupant is within a certain proximity of the interior component. For example, the occupant may be within several inches of the interior component or moving towards the interior component. Movement towards the interior component may be determined based upon analysis of several still images and/or a video capture of the vehicle interior. For example, the image processing module may determine that the driver is reaching for a steering wheel. The image processing module may notify subsystems of the vehicle that an occupant is interacting or preparing to interact with an interior component of the vehicle. Based upon these notifications, the vehicle subsystems may take actions to facilitate the occupant's interaction with the vehicle components at block 360.

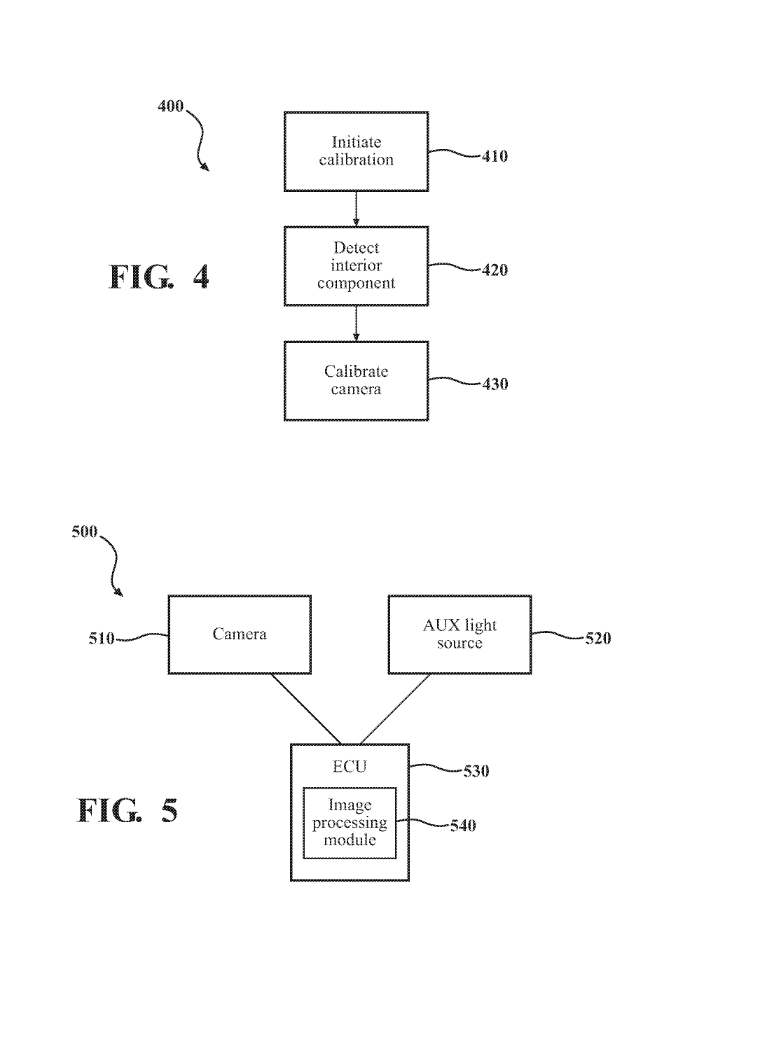

FIG. 4 is a flow diagram of an embodiment of a method 400 of calibrating an occupant detection system. The method 400 may begin at block 410 when calibration is initiated. Calibration of the system may take place upon entry of a vehicle, exit of a vehicle, or at some other time. The calibration may take place when the vehicle is empty, e.g. just prior to an occupant opening a door. Calibration may be initiated based on a change in the interior of the vehicle. For example, detection of movement of interior components of the vehicle, e.g., adjustable seats, adjustable steering wheels, etc. Calibration may also be initiated based upon detection of movement of the camera and/or replacement of the camera. Calibration may be initiated on a periodic basis, e.g. the system calibrates itself monthly or at some other time interval.

After calibration is initiated a block 410, an image processing module may detect one or more interior components of the vehicle. The interior components of the vehicle may be constructed using materials that reflect or absorb electromagnetic spectrum. Different components may reflect or absorb different electromagnetic spectrum. Based upon electromagnetic spectrum detected by the image processing module, the image processing module may calibrate the occupant detection system.

At block 430, the image processing module may calibrate the occupant detection system. In the case where calibration occurs after the camera is moved or replaced, a triangulation process may be used to calibrate the occupant detection system. For example, the occupant detection system may be programmed with the location of interior components of the vehicle. The occupant detection system may use the detected location of the interior components in conjunction with the previously stored location to determine the orientation of the camera. The occupant detection system may then be calibrated based upon this determination.

In the case where calibration occurs after the interior components of the vehicle have been adjusted, distances between objects may be determined using pixel counts or other techniques. The occupant detection system may use a measured distance calculated based upon a captured image in conjunction with previously stored distance information to calibrate the occupant detection system.

FIG. 5 is a block diagram of an embodiment of an occupant detection system 500. The occupant detection system 500 may comprise a camera 510, an auxiliary light source 520, and an electronic control unit (ECU) 530. In some embodiments, more than one camera 510 may be present and/or more than one auxiliary light source 520 may be present. The ECU 530 may comprise an image processing module 540. In some embodiments, the image processing module 540 may be a standalone unit or may be part of some other system within a vehicle. Additionally, in some embodiments, the system may not comprise an auxiliary light source 520. The use of an auxiliary light source 520 may be based upon one or more of the materials used in constructing the interior components of the vehicle or ambient light in and around the vehicle.

Camera 510 may be any type of image capture device. In some embodiments, camera 510 may be a hyperspectral imaging device. In other embodiments, camera 510 may be selected to capture other portions of electromagnetic spectrum. Auxiliary light source 520, may be selected to emit electromagnetic spectrum that is reflected or absorbed by components of the interior of the vehicle. The type of camera 510 and the type of auxiliary light source 520 may be selected to complement each other for occupant detection. In embodiments with multiple cameras 510 and/or multiple auxiliary light sources 520, all may be the same type, or different types of cameras 510 and/or auxiliary light sources 520 may be used in the system.

The image processing module 540 may be software, hardware, or any combination thereof. The image processing module 540 may be configured to receive images captured by the camera 510. The image processing module 540 may be configured to evaluate the received images and determine the presence of occupants, cargo, and/or their movements within the vehicle. The image processing module 540 may be configured to notify various subsystems of the vehicle of the presence of occupants, cargo, and/or their movements within the vehicle.

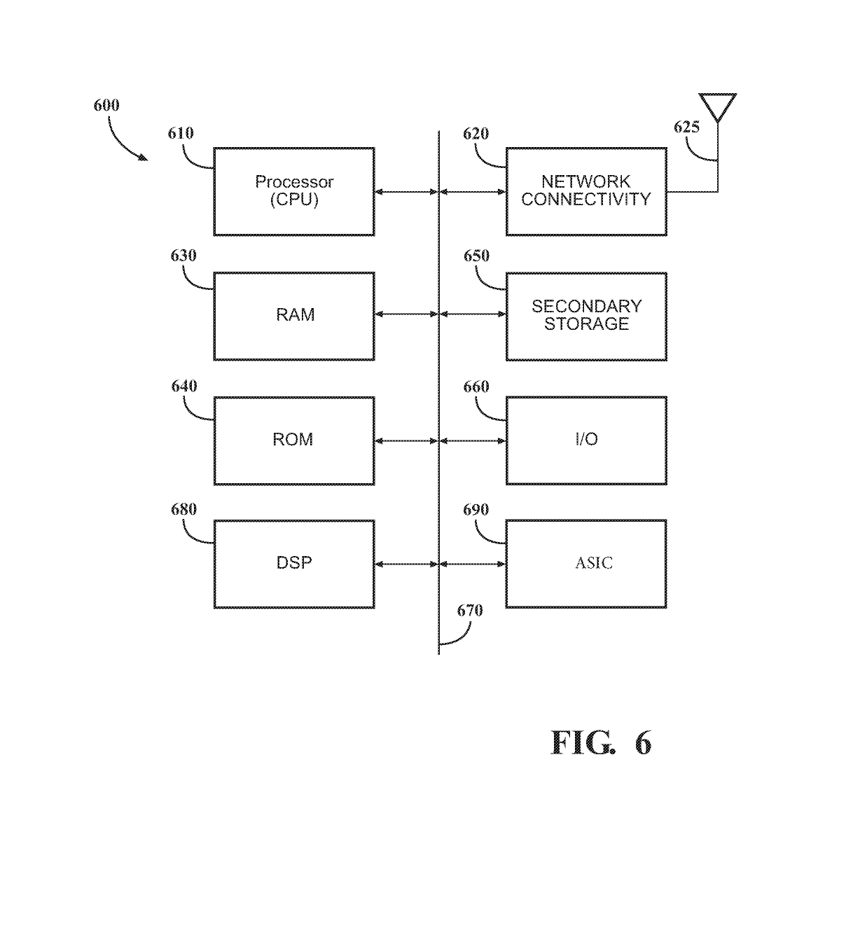

FIG. 6 is a diagram of an embodiment of a system 600 that includes a processor 610 suitable for implementing one or more embodiments disclosed herein, e.g., an ECU 530 and/or an image processing module 540. The processor 610 may control the overall operation of the system.

In addition to the processor 610 (which may be referred to as a central processor unit or CPU), the system 600 might include network connectivity devices 620, random access memory (RAM) 630, read only memory (ROM) 640, secondary storage 650, and input/output (I/O) devices 660. These components might communicate with one another via a bus 670. In some cases, some of these components may not be present or may be combined in various combinations with one another or with other components not shown. These components might be located in a single physical entity or in more than one physical entity. Any actions described herein as being taken by the processor 610 might be taken by the processor 610 alone or by the processor 610 in conjunction with one or more components shown or not shown in the drawing, such as a digital signal processor (DSP) 680 and/or an application-specific integrated circuit (ASIC) 690. Although the DSP 680 is shown as a separate component, the DSP 680 might be incorporated into the processor 610. ASIC 690 may be configured for processing 3D graphics, machine learning, or some other specific application. In some embodiments, one or more ASICs 690 may be present and mat be used for one or more specific applications.

The processor 610 executes instructions, codes, computer programs, or scripts, e.g., an image processing module 540, that it might access from the network connectivity devices 620, RAM 630, ROM 640, or secondary storage 650 (which might include various disk-based systems such as hard disk, floppy disk, or optical disk). While only one CPU 610 is shown, multiple processors may be present. Thus, while instructions may be discussed as being executed by a processor, the instructions may be executed simultaneously, serially, or otherwise by one or multiple processors. The processor 610 may be implemented as one or more CPU chips and may be a hardware device capable of executing computer instructions.

The network connectivity devices 620 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, controller area network (CAN), domestic digital bus (D2B), and/or other well-known devices for connecting to networks. These network connectivity devices 620 may enable the processor 610 to communicate with the Internet or one or more telecommunications networks or other networks from which the processor 610 might receive information or to which the processor 610 might output information. The network connectivity devices 620 might also include one or more transceiver components 625 capable of transmitting and/or receiving data wirelessly.

The RAM 630 might be used to store volatile data and perhaps to store instructions that are executed by the processor 610. The ROM 640 is a non-volatile memory device that typically has a smaller memory capacity than the memory capacity of the secondary storage 650. ROM 640 might be used to store instructions and perhaps data that are read during execution of the instructions. Access to both RAM 630 and ROM 640 is typically faster than to secondary storage 650. The secondary storage 650 is typically comprised of one or more disk drives or tape drives and might be used for non-volatile storage of data or as an over-flow data storage device if RAM 630 is not large enough to hold all working data. Secondary storage 650 may be used to store programs that are loaded into RAM 630 when such programs are selected for execution.

The I/O devices 660 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 625 might be considered to be a component of the I/O devices 660 instead of or in addition to being a component of the network connectivity devices 620.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

It will be understood by one having ordinary skill in the art that construction of the described invention and other components is not limited to any specific material. Other exemplary embodiments of the invention disclosed herein may be formed from a wide variety of materials, unless described otherwise herein.

As used herein, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, arrangements described herein may take the form of a computer program product embodied in one or more computer-readable media having computer-readable program code embodied or embedded, e.g., stored, thereon. Any combination of one or more computer-readable media may be utilized. The computer-readable medium may be a computer-readable signal medium or a computer-readable storage medium. The phrase “computer-readable. storage medium” means a non-transitory storage medium.

What is claimed is:

1. An occupant detection system comprising:
a camera configured to capture at least a first portion of electromagnetic spectrum;
a first interior surface comprising a first material identified by the first portion of electromagnetic spectrum; and
an image processing module configured to:
receive an image from the camera, the image comprising the first portion of electromagnetic spectrum;
detect the first interior surface based, at least in part, upon the image comprising the first portion of electromagnetic spectrum; and
detect a first occupant based, at least in part, on a first absence of the first portion of electromagnetic spectrum in a first area of the image, the first area of the image overlapping the first interior surface in the image.

2. The occupant detection system of claim 1 further comprising an auxiliary light source configured to emit electromagnetic spectrum.

3. The occupant detection system of claim 1 further comprising a second interior surface comprising a second material identified by a second portion of electromagnetic spectrum; wherein the camera is further configured to capture the second portion of electromagnetic spectrum.

4. The occupant detection system of claim 3, wherein the image processing module is further configured to:
detect the second interior surface based, at least in part, upon the image, wherein the image comprises the second portion of electromagnetic spectrum; and
detect an interaction with the second interior surface based, at least in part, on a second absence of the second portion of electromagnetic spectrum in a second area of the image, the second area of the image proximate to the second interior surface in the image.

5. The occupant detection system of claim 4, wherein the image processing module is further configured to transmit an indication of the interaction to a vehicle subsystem associated with the second interior surface.

6. The occupant detection system of claim 4, wherein the second interior surface is one of: a door handle, a steering wheel, a seat belt, a dashboard, an interior light switch, or a cup holder.

7. The occupant detection system of claim 3, wherein the image processing module is further configured to:
detect the second interior surface based, at least in part, upon the image, wherein the image comprises the second portion of electromagnetic spectrum; and
detect a second occupant based, at least in part, on a second absence of the second portion of electromagnetic spectrum in a second area of the image, the second area of the image overlapping the second interior surface in the image.

8. The occupant detection system of claim 1, wherein the camera is further configured to capture a second portion of electromagnetic spectrum, and the first interior surface further comprises a second material identified by the second portion of electromagnetic spectrum, and wherein the image processing module is further configure to detect the first interior surface based, at least in part, upon the image comprising a pattern, the pattern comprising the first portion of electromagnetic spectrum and the second portion of electromagnetic spectrum.

9. The occupant detection system of claim 1, wherein the camera is a hyperspectral camera.

10. A method for occupant detection, the method comprising:
receiving an image comprising at least a first portion of electromagnetic spectrum;
detecting a first interior surface based, at least in part, upon the image comprising the first portion of electromagnetic spectrum; and
detecting a first occupant based, at least in part, on a first absence of the first portion of electromagnetic spectrum in a first area of the image, the first area of the image overlapping a first interior surface in the image.

11. The method of claim 10 further comprising emitting electromagnetic spectrum from an auxiliary light source.

12. The method of claim 10 further comprising:
detecting a second interior surface based, at least in part, upon the image, wherein the image comprises a second portion of electromagnetic spectrum; and
detecting an interaction with the second interior surface based, at least in part, on a second absence of the second portion of electromagnetic spectrum in a second area of the image, the second area of the image proximate to the second interior surface in the image.

13. The method of claim 12 further comprising transmitting an indication of the interaction to a vehicle subsystem associated with the second interior surface.

14. The method of claim 10 further comprising:
detecting a second interior surface based, at least in part, upon the image, wherein the image comprises a second portion of electromagnetic spectrum; and
detecting a second occupant based, at least in part, on a second absence of the second portion of electromagnetic spectrum in a second area of the image, the second area of the image overlapping the second interior surface in the image.

15. A vehicle comprising:
a camera configured to capture at least a first portion of electromagnetic spectrum;
a first interior surface comprising a first material identified by the first portion of electromagnetic spectrum; and
an image processing module configured to:
receive an image from the camera, the image comprising the first portion of electromagnetic spectrum;
detect the first interior surface based, at least in part, upon the image comprising the first portion of electromagnetic spectrum; and
detect a first occupant based, at least in part, on a first absence of the first portion of electromagnetic spectrum in a first area of the image, the first area of the image overlapping the first interior surface in the image.

16. The vehicle of claim 15 further comprising an auxiliary light source configured to emit electromagnetic spectrum.

17. The vehicle of claim 15 further comprising a second interior surface comprising a second material identified by a second portion of electromagnetic spectrum; wherein the camera is further configured to capture the second portion of electromagnetic spectrum.

18. The vehicle of claim 17, wherein the image processing module is further configured to:
detect the second interior surface based, at least in part, upon the image, wherein the image comprises the second portion of electromagnetic spectrum; and
detect an interaction with the second interior surface based, at least in part, on a second absence of the second portion of electromagnetic spectrum in a second area of the image, the second area of the image proximate to the second interior surface in the image.

19. The vehicle of claim 18, wherein the image processing module is further configured to transmit an indication of the interaction to a vehicle subsystem associated with the second interior surface.

20. The vehicle of claim 18, wherein the second interior surface is one of: a door handle, a steering wheel, a seat belt, a dashboard, an interior light switch, or a cup holder.
